(19) United States
(12) Patent Application Publication
(10) Pub. No.: US 2006/0172752 A1
(43) Pub. Date: Aug. 3, 2006

(54) Method and apparatus for providing talk permit notification for a PTT call

(76) Inventors: John M. Harris, Chicago, IL (US); Ronald T. Crocker, St. Charles, IL (US); Thomas B. Hart, West Dundee, IL (US)

Correspondence Address: MOTOROLA, INC., 1303 EAST ALGONQUIN ROAD, IL01/3RD, SCHAUMBURG, IL, 60196, US

(21) Appl. No.: 11/049,770

(22) Filed: Feb. 3, 2005

(51) Int. Cl. H04Q 7/20

(52) U.S. Cl. 455/518

(57) ABSTRACT

Various embodiments are described to provide push to talk (PTT) talk permit notification (TPN) with less average delay, given a desired rate of falsing, than prior art systems can achieve. A first communication system device (e.g., 101, 121, or 161) determines (504) whether one or more conditions are present for a PTT call that decrease the likelihood of successfully establishing the call. If (506) one or more conditions are present or a querying delay is expected to be less than an acceptable delay amount, the first device queries (508) a second communication system device (e.g., 121, 161, 122, or 102) for an indication to proceed with a TPN for the call before providing the TPN. Otherwise, the first device provides (512) the TPN without waiting for an indication to proceed with the TPN from the second device.

### FIELD OF THE INVENTION

The present invention relates generally to communication systems and, in particular, to providing talk permit notification (TPN) for push to talk (PTT) calls.

### BACKGROUND OF THE INVENTION

In push to talk (PTT) calling systems, a caller initiates a PTT call by triggering a PTT activation. For example, the caller may depress a PTT key on a mobile handset to trigger the PTT activation. In the moments that follow, it is common to provide a talk permit notification (TPN) to signal the caller that he or she may begin speaking. The shorter the interval between PTT activation and TPN, the more responsive the system feels to callers and generally the better their overall user experience is.

In order to reduce this interval, some existing systems provide the TPN before the PTT call has been fully established. If the TPN is provided to the caller, but the PTT call then cannot be fully established, the caller may begin speaking and later realize that the called party has not heard what was said. Needless to say, this falsing of the TPN can be quite frustrating to users. Thus, it is desirable to reduce both the average TPN delay and the average rate of falsing. However, typically TPN delay must be increased to reduce the rate of falsing.

Accordingly, it would be desirable to have a method and apparatus for providing TPN with less average delay, given a desired rate of falsing, than prior art systems can achieve.

### BRIEF DESCRIPTION OF THE DRAWINGS

FIG. 1 is a block diagram depiction of a wireless communication system in accordance with multiple embodiments of the present invention.

FIG. 2 is an exemplary call flow diagram depicting a call setup scenario in which a TPN is provided after confirmation is obtained from a target PTT client, in accordance with multiple embodiments of the present invention.

FIG. 3 is an exemplary call flow diagram depicting a call setup scenario in which a TPN is provided after receiving an indication to proceed from a PTT-on-cellular (PoC) server, in accordance with multiple embodiments of the present invention.

FIG. 4 is an exemplary call flow diagram depicting a call setup scenario in which a TPN is provided without querying a PoC server for an indication to proceed, in accordance with multiple embodiments of the present invention.

FIG. 5 is a logic flow diagram of functionality that may be performed by a communication system device (including user equipment (UE) and various fixed network devices) to provide a TPN, in accordance with multiple embodiments of the present invention.

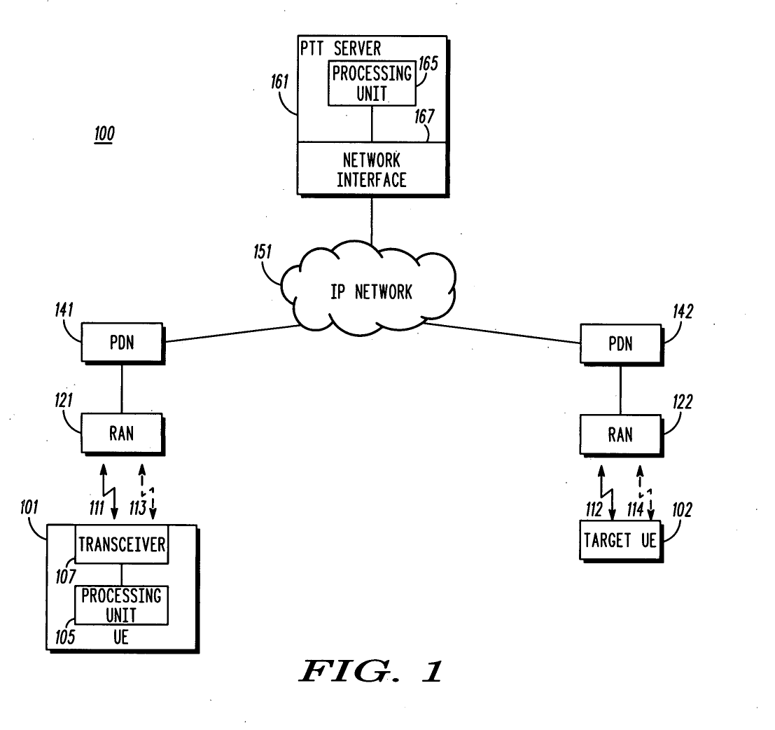

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described to provide push to talk (PTT) talk permit notification (TPN) with less average delay, given a desired rate of falsing, than prior art systems can achieve. A first communication system device (e.g., 101, 121, or 161) determines (504) whether one or more conditions are present for a PTT call that decrease the likelihood of successfully establishing the call. If (506) one or more conditions are present or a querying delay is expected to be less than an acceptable delay amount, the first device queries (508) a second communication system device (e.g., 121, 161, 122, or 102) for an indication to proceed with a TPN for the call before providing the TPN. Otherwise, the first device provides (512) the TPN without waiting for an indication to proceed with the TPN from the second device. Thus, the described embodiments determine on a per-call basis whether or not to incur additional delay in order to avoid possibly falsing the TPN for this call.

The disclosed embodiments can be more fully understood with reference to FIGS. 1-5. FIG. 1 is a block diagram depiction of a wireless communication system 100 in accordance with multiple embodiments of the present invention. At present, standards bodies such as OMA (Open Mobile Alliance), 3GPP (3rd Generation Partnership Project) and 3GPP2 (3rd Generation Partnership Project 2) are developing standards specifications for wireless telecommunication systems. (These groups may be contacted via http://www.openmobilealliance.com, http://www.3gpp.org/ and http://www.3gpp2.com/, respectively.) Communication system 100 represents a system having an architecture in accordance with one or more of the 3GPP2 technologies (e.g., CDMA 2000 and HRPD (also known as 1xEV-DO or IS-856)), suitably modified, as needed, to implement the present invention. Alternative embodiments of the present invention may be implemented in communication systems that employ other or additional technologies such as, but not limited to, those described in the 3GPP specifications (e.g., GSM, GPRS, EDGE, W-CDMA, UTRAN, FOMA, UMTS, HSDPA, and HSUPA), those described in the IEEE's 802.11, 802.16, and 802.20 specifications, those described in the OMA standards specifications, those described in the IS-136 (TDMA Third Generation Wireless Standards) specification, those described in the IS-95 (CDMA) specification, 1xEV-DV technologies, and integrated dispatch enhanced network technologies.

More specifically, communication system 100 comprises user equipment (UE) 101 and 102, radio access networks (RANs) 121 and 122, packet data networks 141 and 142, IP (internet protocol) network 151, and PTT server 161. Those skilled in the art will recognize that FIG. 1 does not depict all of the network equipment necessary for system 100 to operate but only those system components and logical entities particularly relevant to the description of embodiments herein. For example, packet data networks are known to comprise devices such as packet data serving nodes (PDSNs). Also, RANs are known to comprise devices such as base transceiver stations (BTSs), base site controllers (BSCs), and packet control functions (PCFs). However, none of these devices are specifically shown in FIG. 1.

PTT server 161 is depicted in FIG. 1 as comprising processing unit 165 and network interface 167. In general, components such as processing units and network interfaces are well-known. For example, server processing units are known to comprise basic components such as, but not limited to, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using messaging flow diagrams, and/or expressed using logic flow diagrams.

Thus, given an algorithm, a logic flow, a messaging flow, and/or a protocol specification, those skilled in the art are aware of the many design and development techniques available to implement a server processing unit that performs the given logic. Therefore, PTT server 161 represents a known PTT server that has been adapted, in accordance with the description herein, to implement multiple embodiments of the present invention. Furthermore, those skilled in the art will recognize that aspects of the present invention may be implemented in and across various physical components and none are necessarily limited to single platform implementations. For example, the PTT server aspect of the present invention may be implemented in a RAN, in a PDN, on a dedicated network server platform, or distributed such components.

RANs 121 and 122 use air interfaces comprising channel groups 111-114 for communication with UEs 101 and 102. 3GPP2 channel groups 111 and 112 each comprise a variety of well-known non-traffic channel types, such as broadcast channels, paging channels, access channels and common control channels, in accordance with the particular 3GPP2 signaling technology used. 3GPP2 channel groups 113 and 114 each comprise dedicated traffic channels, which are dynamically assigned and de-assigned to support user services, again in accordance with the particular 3GPP2 signaling technology used.

UEs may be thought of as mobile stations (MSs); however, UEs are not necessarily mobile nor able to move. Thus, UE platforms are known to refer to a wide variety of consumer electronic platforms such as, but not limited to, mobile stations (MSs), access terminals (ATs), terminal equipment, gaming devices, personal computers, personal digital assistants (PDAs), cable set-top boxes and satellite set-top boxes. In particular, UE 101 comprises processing unit 105, transceiver 107, a keypad (not shown), a speaker (not shown), a microphone (not shown), and a display (not shown). Processing units, transceivers, keypads, speakers, microphones, and displays as used in UEs are all well-known in the art.

For example, UE processing units are known to comprise basic components such as, but not limited to, microprocessors, digital signal processors (DSPs), microcontrollers, memory devices, application-specific integrated circuits (ASICs), and/or logic circuitry. Such MS components are typically adapted to implement algorithms and/or protocols that have been expressed using high-level design languages or descriptions, expressed using computer instructions, expressed using messaging flow diagrams, and/or expressed using logic flow diagrams. Thus, given an algorithm, a logic flow, a messaging/signaling flow, a call flow, and/or a protocol specification, those skilled in the art are aware of the many design and development techniques available to implement user equipment that performs the given logic. Therefore, UE 101 represents a known UE that has been adapted, in accordance with the description herein, to implement embodiments of the present invention.

Operation of various embodiments in accordance with the present invention occur substantially as follows. In general, the various embodiments involve determining whether to query another communication system device for an indication to proceed with a talk permit notification (TPN) for the PTT call before providing the TPN. The device making this determination may be either a UE device or a fixed network device. For example, after detecting a PTT activation by its user and before providing the user a TPN, UE processing unit 105 determines whether one or more conditions are present for the PTT call that would indicate a decreased likelihood of successfully establishing the PTT call.

Two conditions that decrease the likelihood of success are when the PTT call is either a private call (i.e., a one-to-one PTT call) or a group call (i.e., a one-to-many PTT call) for which all the group members must be available to establish the call. As compared to a regular group call, where only one of the PTT targets is required to establish the call, both of these conditions have a lower chance of success, since all of the targets must be available. Two additional conditions that decrease the likelihood of success are when the PTT target(s) has not recently performed any presence signaling or recently responded to a PTT talk burst.

Thus, if UE processing unit 105 determines that one of these conditions is present, it queries, via transceiver 107 and channel group 111, another communication system device for an indication to proceed with a TPN for the PTT call. Alternatively, if UE processing unit 105 expects that a querying delay is going to be acceptable (2 seconds, for example), it may also query for an indication to proceed with the TPN. For example, for certain system architectures UE 101 may be able to anticipate that the fixed network will receive a page response from target UE 102 prior to completing the establishment of a traffic channel from channel group 113. In such a situation, the querying delay may be little more than a query-and-response round trip time. Also, some systems may be designed with features that enable responses to such queries within an acceptable period of time. In any case, what constitutes an acceptable delay amount can be set and/or modified by a system operator.

On average, querying should reduce the rate of TPN falsing. Thus, querying is expected to be beneficial whenever the required delay is acceptable. Moreover, for situations where there is reason to anticipate a greater chance of not establishing the call, the benefits of querying should be the greatest.

If UE processing unit 105 expects that a querying delay is going to be acceptable or it determines a condition indicating a decreased likelihood of establishing the PTT call is present, then UE 101 queries another communication system device before providing a TPN for the PTT call. Otherwise, UE processing unit 105 provides the TPN without waiting for an indication from the other communication system device to proceed with the TPN. For a UE, providing the TPN involves notifying the user by some means. For example, UE 101 may play a tone on its speaker, vibrate or signal the user via its display. Also, querying another device is sometimes referred to as “check with server” operation, “check with target” operation or “check with other” operation, while not querying may referred to as “check with self” operation.

Although UE 101 may decide not to wait for an indication to proceed with the TPN, “check with self” operation, UE processing unit 105 may wait for a particular call-setup event, in some embodiments, before providing the TPN. For example, UE processing unit 105 may wait to receive signaling, via transceiver 107 and channel group 111, in response to UE origination messaging or UE reverse short data burst signaling for the PTT call. Such response signaling may take the form of a base station acknowledgment (BS ACK). Other examples of call-setup events for which UE processing unit 105 may wait include receiving channel assignment messaging for the PTT call (for example, a channel assignment or enhanced channel assignment message (ECAM)) or receiving signaling on a traffic channel assigned for the PTT call (for example, null data or a BS ACK).

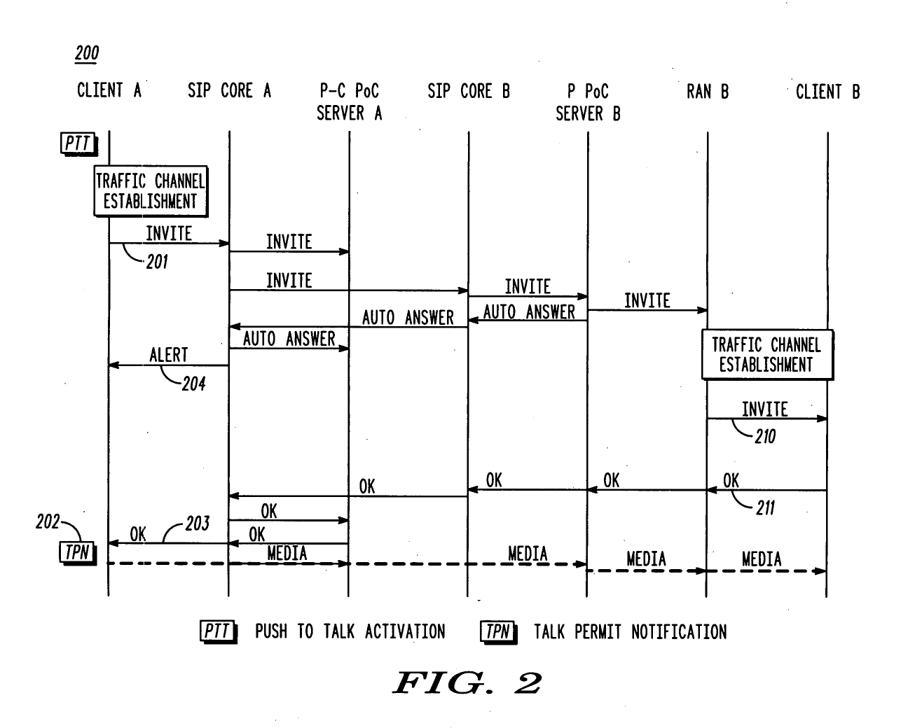

Some of the functionality described above is illustrated in FIGS. 2-4. FIGS. 2-4 depict messaging flows between functional entities that are consistent with those described in present OMA specifications. For example, the PoC Client resides on a mobile terminal/UE and is used to access the PoC service. The PoC Server implements the application level network functionality for the PoC service by performing one or more functional roles, as a Controlling PoC Function and/or as a Participating PoC Function. In a PoC Session there is only one PoC Server performing as the Controlling PoC Function, while there can be one or more PoC Servers performing as a Participating PoC Function, since the Participating PoC Function is performed once per PoC Client for all incoming/outgoing PoC Sessions. Thus, the sessions depicted in FIGS. 2-4 involve a Participating-Controlling (P-C) PoC server function and a Participating (P) PoC server function.

As an example, the PoC Server may perform the following functions when it fulfills the Controlling PoC Function: providing centralized PoC Session handling, providing centralized media distribution, providing centralized talk burst arbitration functionality including talker identification, providing Session Initiation Protocol (SIP) session handling, such as SIP session origination, termination, etc., providing policy enforcement for participation in group sessions, providing the participants information, collecting and providing centralized media quality information, providing centralized charging reports, supporting user plane adaptation procedures, providing transcoding between different codecs, and supporting talk burst control protocol negotiation. As an example, the PoC Server may perform the following functions when it fulfills the Participating PoC Function: providing PoC session handling, supporting user plane adaptation procedures, providing the talk burst control message relay function between PoC Client and PoC Server performing the Controlling PoC Function, providing SIP session handling, such as SIP Session origination, termination, etc., on behalf of the represented PoC Client, providing policy enforcement for incoming PoC session (e.g. access control, incoming PoC session barring, availability status, etc), providing Participant charging reports, supporting talk burst control protocol negotiation, storing the current answer mode and incoming PoC session barring preferences of the PoC Client. When the participating PoC Function is on the media path, the PoC Server may also perform the following functions: providing the media relay function between PoC Client and PoC Server, performing the Controlling PoC Function, providing a talk burst control message relay function between PoC Client and PoC Server performing the Controlling PoC Function, collecting and providing media quality information, providing filtering of the media streams in the case of simultaneous sessions, and providing transcoding between different codecs.

As a final example, the SIP/IP Core includes a number of SIP proxies and SIP registrars, which may perform the following functions in support of the PoC service: routing the SIP signaling between the PoC Client and the PoC Server, providing discovery and address resolution services, supporting SIP compression, performing authentication and authorization of the PoC user at the PoC Client based on the PoC user's service profile, maintaining the registration state, providing support for identity privacy on the control plane, providing charging information, providing capabilities to lawful interception, and supporting lawful interception functionality.

Since FIGS. 2-4 depict messaging flows between OMA functional entities discussed above (the PoC Client, the Controlling PoC server function and/or Participating PoC server function, and the SIP/IP Core), they do not directly map to the system components depicted in FIG. 1. As such, they may be distributed among the FIG. 1 system components in a variety of ways. In some embodiments (and also for certain calling scenarios in those embodiments), the SIP/IP Core and the Controlling and Participating PoC server functions may all be implemented in one or more PTT servers such as PTT server 161. In other embodiments, the SIP/IP Core and the Controlling and Participating PoC server functions may be distributed across RANs, PDNs, and PTT servers. Certainly, many possibilities are apparent to one of skill in the art, each having a different mix of design tradeoffs.

FIG. 2 is an exemplary call flow diagram depicting a call setup scenario in which a TPN is provided after confirmation is obtained from a target PTT client, in accordance with multiple embodiments of the present invention. Thus, call flow 200 illustrates a PTT call where the originating client/UE either expected that a querying delay was going to be acceptable or determined that a condition indicating a decreased likelihood of establishing the PTT call was present. Thus, the client/UE queried another communication system device for an indication to proceed with a TPN. In some embodiments, this query is included in SIP INVITE messaging (such as INVITE 201) indicating that the client/UE is waiting to proceed with a TPN.

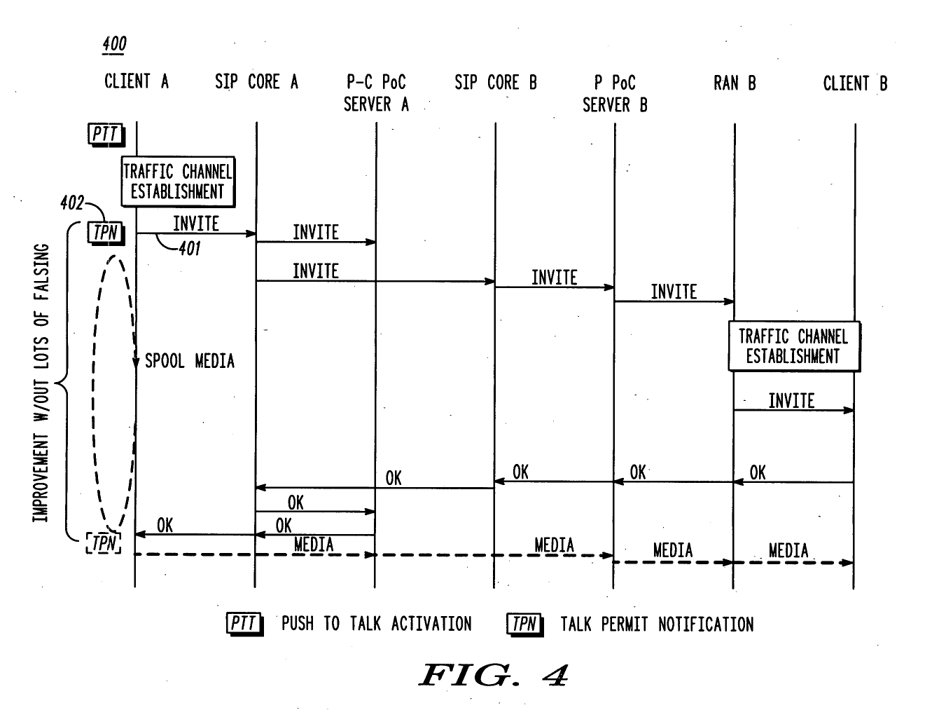

In contrast, FIG. 4 is an exemplary call flow diagram depicting a call setup scenario in which TPN 402 is provided without querying a PoC server or waiting for an indication to proceed, in accordance with multiple embodiments of the present invention. Thus, unlike INVITE 201, INVITE 401 in call flow 400 does not include a query and may indicate whether or not the client/UE has already provided TPN 402. The fixed network equipment (such as RANs 121 and 122, PDNs 141 and 142, and/or PTT server 161) may use this indication of whether or not the TPN has already been provided to determine how to signal a PTT target. For example, if the TPN has already been provided, the target RAN should try to get the PTT target on a traffic channel as soon as possible. Alternatively, if the PTT originator is querying for an indication to proceed, the target RAN should try to get some response from the PTT target as soon as possible.

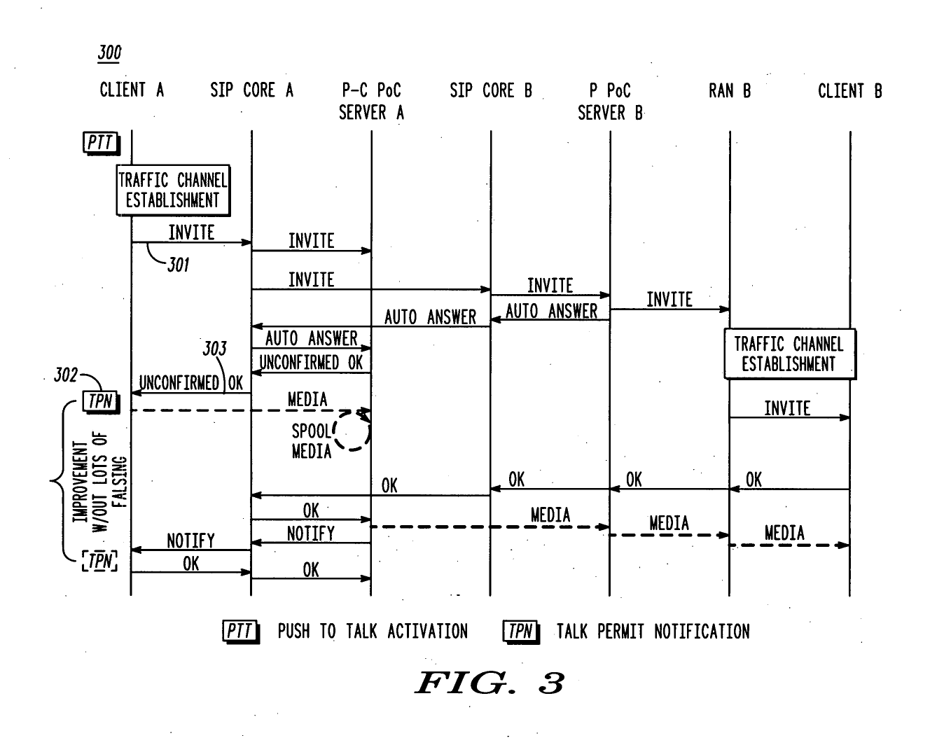

FIG. 3 is an exemplary call flow diagram depicting a call setup scenario in which a TPN is provided after receiving an indication to proceed from a PTT-on-cellular (PoC) server, in accordance with multiple embodiments of the present invention. Similar to call flow 200, call flow 300 illustrates a PTT call where the originating client/UE queries (via INVITE 301) another communication system device for an indication to proceed with TPN 302. Unlike call flow 200, however, the call flow 300 originating client/UE receives a different indication to proceed from the other communication system device. In call flow 200, SIP 200 OK 203 indicates to the originating client to proceed with TPN 202. However, in call flow 300, UNCONFIRMED OK 303 indicates to the originating client to proceed with TPN 302. In some embodiments, the fixed network equipment will indicate in messaging such as UNCONFIRMED OK 303 or ALERT 204 whether the originating client/UE may proceed with a TPN or should continue to wait for subsequent messaging.

Therefore, when UE processing unit 105 queries another communication system device for an indication to proceed with a TPN, UE processing unit 105 may receive, via UE transceiver 107, an explicit indication to proceed or messaging that when sent indicates a condition exists which UE processing unit 105 may consider sufficient as an indicator to proceed with a TPN. Depending on the embodiment, such conditions may include some or all of the following: a condition where the RF environment of a PTT target of the PTT call has not recently been poor, a condition where presence signaling has recently occurred with a PTT target of the PTT call, a condition where a RAN of a PTT target has resources to support the PTT call, a condition where a PTT target of the PTT call has registered and is not busy, a condition where a page response has been received from a PTT target of the PTT call, a condition where a reverse short data burst has been received from a PTT target of the PTT call, a condition where acknowledgment signaling has been received from a PTT target of the PTT call, and a condition where signaling has been received from a PTT target on a traffic channel assigned for the PTT call. For example, UE processing unit 105 may receive a SIP 100 TRYING message or a SIP 200 OK message and know that these messages are sent only when one or more of these conditions are present.

In some embodiments, UE processing unit 105 will not provide a TPN without querying and waiting for an indication to proceed until UE processing unit 105 receives an indication from the fixed network equipment that UE 101 may provide TPNs without waiting. In other words, UE 101 may need authorization before operating in a “check with self” mode. This authorization may be given during registration procedures or be given dynamically post-registration. However, the authorization may be dependent upon the presence of one or more conditions. These autonomous TPN conditions may include the following: a condition in which a number of PTT targets of the PTT call is greater than a threshold, a condition in which an amount of time since communication was received from a PTT target of the PTT call is less than a threshold, a condition in which a PTT target of the PTT call is a member of a designated set of PTT targets, a condition in which a PTT target of the PTT call has certain PTT attributes, and a condition in which a PTT target of the PTT call has certain presence attributes.

As noted above, various embodiments are described herein that involve determining whether to query another communication system device for an indication to proceed with a TPN before providing the TPN. The device making this determination may be either a UE device or a fixed network device. Depending on the embodiment, the fixed network device could be a RAN (such as RAN 121 or RAN 122) or a PoC server (such as PTT server 161 and/or other devices that comprise aspects of the PoC server). For clarity of description, a single system component, PTT server 161, will be used as an example.

Unlike UE 101, PTT server 161 does not detect a user PTT activation but rather it receives an indication from UE 101, via RAN 121 and PDN 141, that a PTT activation has a occurred and that UE 101 is waiting for an indication to provide a TPN for the PTT call. For example, as depicted in FIGS. 2 and 3, this indication may take the form of INVITE 201 or INVITE 301. Before providing the user a TPN, PTT server processing unit 165 determines whether one or more conditions are present for the PTT call that would indicate a decreased likelihood of successfully establishing the PTT call.

Two conditions that decrease the likelihood of success are when the PTT call is either a private call (i.e., a one-to-one PTT call) or a group call (i.e., a one-to-many PTT call) for which all the group members must be available to establish the call. Additional conditions that decrease the likelihood of success include a condition where a PTT target of the PTT call recently dropped due to RF loss, a condition where an RF environment of a PTT target has recently been poor, a condition where a serving cell of a PTT target effectively has no resources, a condition where no signaling (presence, call activity, etc.) has recently occurred with a PTT target, a condition where a PTT target has unchecked voice mail or e-mail, a condition where a PTT target has not responded to a recent short message service message, a condition where a PTT target has not responded to a recent PTT talk burst, and a condition where a PTT target has a low battery. Depending on the embodiment, PTT server processing unit 165 may only consider the presence of some of these conditions or only have sufficient information to consider some of them.

Thus, if PTT server processing unit 165 determines that one of these conditions is present, it queries, via network interface 167, another communication system device for an indication to proceed with a TPN for the PTT call. Alternatively, if PTT server processing unit 165 expects that a querying delay is going to be acceptable (2 seconds, for example), it may also query for an indication to proceed with the TPN. For example, some systems may be designed with features that enable responses to such queries within an acceptable period of time. In any case, what constitutes an acceptable delay amount can be set and/or modified by a system operator.

If PTT server processing unit 165 expects that a querying delay is going to be acceptable or it determines a condition indicating a decreased likelihood of establishing the PTT call is present, then PTT server 161 queries another communication system device before providing a TPN for the PTT call. Otherwise, PTT server processing unit 165 provides the TPN without waiting for an indication from the other communication system device to proceed with the TPN. For a PTT server (or other fixed network device), providing the TPN involves indicating to the waiting UE that a TPN may be provided to the user. For example, as depicted in FIG. 3, such an indication may take the form of UNCONFIRMED OK 303.

In the case where PTT server 161 queries another communication system device before providing a TPN for the PTT call, at least a couple of options exist. The communication system device queried may be a PTT target, such as UE 102, or a RAN serving the PTT target, such as RAN 122. For example, call flow 200 depicts querying PTT target client B using INVITE 210. Client B responds with SIP 200 OK 211 which eventually indicates to the PoC server that it may proceed to provide a TPN. SIP 200 OK 203 is then used to indicate to client A that it should proceed with TPN 202. In another example, PTT server 161 queries target UE 102 by soliciting a page response or reverse short data burst from UE 102 via channel group 112. Upon receiving an indication that UE 102 responded, PTT server could indicate to UE 101 to provide the TPN for the PTT call.

However, PTT server 161 may prefer to query RAN 122 instead of UE 102 to get a faster response. RAN 122 may have information that PTT server 161 does not, and this information may indicate that a condition exists for a PTT target(s) which may be considered sufficient to proceed with a TPN. Depending on the embodiment, such conditions may include some or all of the following: a condition where the RF environment of a PTT target of the PTT call has not recently been poor, a condition where presence signaling has recently occurred with a PTT target of the PTT call, a condition where the RAN of a PTT target of the PTT call has resources to support the PTT call, a condition where a PTT target of the PTT call has registered and is not busy, a condition where a page response has been received from a PTT target of the PTT call, a condition where a reverse short data burst has been received from a PTT target of the PTT call, a condition where acknowledgment signaling has been received from a PTT target of the PTT call, and a condition where signaling has been received from a PTT target on a traffic channel assigned for the PTT call. In some embodiments, RAN 122 may simply determine whether it is aware of some reason that a PTT target will not be available. If it is not aware of any such reason, RAN 122 responds to PTT server 161 with an indication to proceed with the TPN. The indication to proceed with the TPN, whatever the basis for determining, may take the form of a SIP 100 TRYING message.

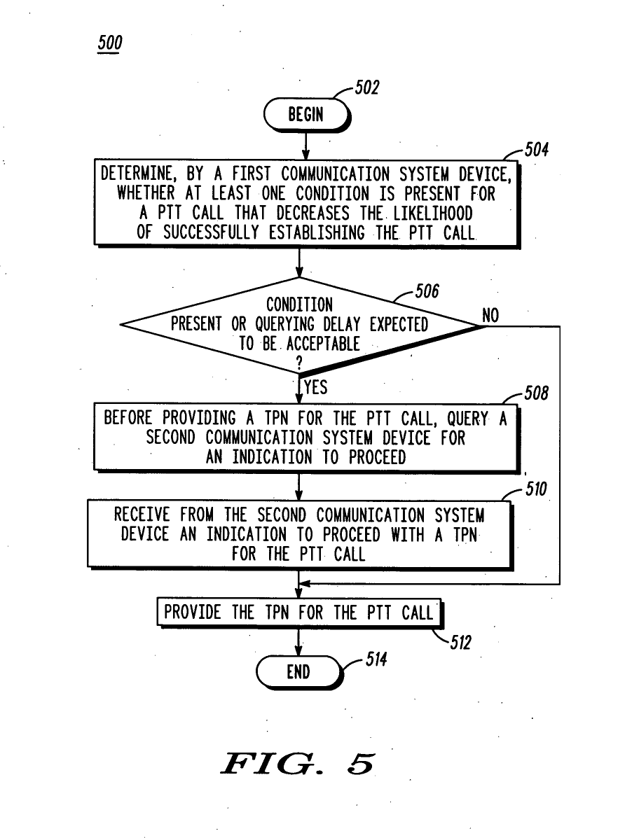

FIG. 5 is a logic flow diagram of functionality that may be performed by a communication system device (including user equipment (UE) and various fixed network devices) to provide a TPN, in accordance with multiple embodiments of the present invention. Logic flow 500 begins (502) with a first communication system device determining (504) whether at least one condition is present for the PTT call that decreases the likelihood of successfully establishing the PTT call. If (506) the at least one condition is present for the PTT call or a querying delay is expected to be less than an acceptable delay amount, then a second communication system device is queried (508) for an indication to proceed with a TPN for the PTT call before providing the TPN. The first communication system device then waits to receive (510) an indication to proceed with a TPN for the PTT call from the second communication system device. Having either received this indication to proceed or having determined that at least one condition is not present and that a querying delay is not expected to be less than an acceptable delay amount, the first communication system device provides (512) the TPN for the PTT call and logic flow 500 ends (514).

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for providing talk permit notification (TPN) for a push to talk (PTT) call, the method comprising:
determining, by a first communication system device, whether at least one condition is present for the PTT call that decreases the likelihood of successfully establishing the PTT call;
if the at least one condition is present for the PTT call or a querying delay is expected to be less than an acceptable delay amount, querying a second communication system device for an indication to proceed with a TPN for the PTT call before providing the TPN; and
if the at least one condition is not present for the PTT call, providing the TPN without waiting for an indication to proceed with the TPN from the second communication system device.

2. The method of claim 1, wherein the at least one condition for the PTT call that decreases the likelihood of successfully establishing the PTT call is at least one condition from the group consisting of
a condition where the PTT call is a private call,
a condition where the PTT call is a group call for which all the group members must be available to establish the call,
a condition where a PTT target of the PTT call recently dropped due to RF loss,
a condition where an RF environment of a PTT target of the PTT call has recently been poor,
a condition where a serving cell of a PTT target of the PTT call effectively has no resources,
a condition where no signaling has recently occurred with a PTT target of the PTT call,
a condition where a PTT target of the PTT call has unchecked voice mail,
a condition where a PTT target of the PTT call has unchecked e-mail,
a condition where a PTT target of the PTT call has not responded to a recent short message service message,
a condition where a PTT target of the PTT call has not responded to a recent PTT talk burst, and
a condition where a PTT target of the PTT call has a low battery.

3. The method of claim 1, further comprising
receiving from the second communication system device an indication to proceed with a TPN for the PTT call.

4. The method of claim 3, wherein the indication to proceed with a TPN for the PTT call comprises an indication that at least one condition is present from the group consisting of
a condition where an RF environment of a PTT target of the PTT call has not recently been poor,
a condition where presence signaling has recently occurred with a PTT target of the PTT call,
a condition where a radio access network (RAN) of a PTT target of the PTT call has resources to support the PTT call,
a condition where a PTT target of the PTT call has registered and is not busy,
a condition where a page response has been received from a PTT target of the PTT call,
a condition where a reverse short data burst has been received from a PTT target of the PTT call,
a condition where acknowledgment signaling has been received from a PTT target of the PTT call,
a condition where signaling has been received from a PTT target on a traffic channel assigned for the PTT call.

5. The method of claim 1, wherein the first communication system device comprises a PTT server, wherein the second communication system device comprises a device from the group consisting of a PTT target and a radio access network (RAN) serving the PTT target, and wherein providing the TPN comprises indicating to user equipment (UE) to provide the TPN.

6. The method of claim 5, wherein querying the second communication system device for an indication to proceed with a TPN for the PTT call comprises soliciting a page response or reverse short data burst from the PTT target and
wherein the method further comprises not soliciting a page response or reverse short data burst from the PTT target if the at least one condition is not present for the PTT call.

7. The method of claim 1, wherein the first communication system device comprises user equipment (UE).

8. The method of claim 7, further comprising
receiving, by the UE prior to initiating the PTT call, an indication that the UE may provide TPNs without waiting for indications to proceed with the TPNs from the second communication system device.

9. The method of claim 8, wherein receiving the indication that the UE may provide TPNs without waiting for indications to proceed with the TPNs comprises
receiving an indication that the UE may provide TPNs without waiting for indications to proceed with the TPNs when at least one autonomous TPN condition is present.

10. The method of claim 9, wherein the at least one autonomous TPN condition is a condition from the group consisting of:
a number of PTT targets of the PTT call is greater than a threshold,
an amount of time since communication was received from a PTT target of the PTT call is less than a threshold,
a PTT target of the PTT call is a member of a designated set of PTT targets,
a PTT target of the PTT call has certain PTT attributes, and
a PTT target of the PTT call has certain presence attributes.

11. The method of claim 7, wherein querying the second communication system device for an indication to proceed with a TPN for the PTT call before providing the TPN comprises
indicating, by the UE in an INVITE message, that the UE is waiting to proceed with the TPN.

12. The method of claim 7, wherein providing the TPN without waiting for an indication to proceed with the TPN from the second communication system device comprises waiting for an event from the group consisting of
receiving signaling in response to UE origination messaging for the PTT call,
receiving signaling in response to UE reverse short data burst signaling for the PTT call,
receiving channel assignment messaging for the PTT call, and
receiving signaling on a traffic channel assigned for the PTT call.

13. User equipment (UE) for providing talk permit notification (TPN) for a push to talk (PTT) call, the UE comprising:
a transceiver; and
a processing unit, communicatively coupled to the transceiver,
adapted to determine whether at least one condition is present for the PTT call that decreases the likelihood of successfully establishing the PTT call,
adapted to query, via the transceiver, a communication system device for an indication to proceed with a TPN for the PTT call, before providing the TPN, if the at least one condition is present for the PTT call or a querying delay is expected to be less than an acceptable delay amount, and
adapted to provide the TPN without waiting for an indication to proceed with the TPN from the second communication system device if the at least one condition is not present for the PTT call.

14. The UE of claim 13, wherein the at least one condition for the PTT call that decreases the likelihood of successfully establishing the PTT call is at least one condition from the group consisting of
a condition where the PTT call is a private call,
a condition where the PTT call is a group call for which all the group members must be available to establish the call,
a condition where a PTT target of the PTT call recently dropped due to RF loss,
a condition where an RF environment of a PTT target of the PTT call has recently been poor,
a condition where a serving cell of a PTT target of the PTT call effectively has no resources,
a condition where no signaling has recently occurred with a PTT target of the PTT call,
a condition where a PTT target of the PTT call has unchecked voice mail,
a condition where a PTT target of the PTT call has unchecked e-mail,
a condition where a PTT target of the PTT call has not responded to a recent short message service message,
a condition where a PTT target of the PTT call has not responded to a recent PTT talk burst, and
a condition where a PTT target of the PTT call has a low battery.

15. The UE of claim 13, wherein the processing unit is further
adapted to receive, via the transceiver prior to initiating the PTT call, an indication that the UE may provide TPNs without waiting for indications to proceed with the TPNs from the second communication system device.

16. The UE of claim 13, wherein the processing unit is further
adapted to query by indicating, in an INVITE message, that the UE is waiting to proceed with the TPN.

17. The UE of claim 13, wherein the processing unit is further adapted to provide the TPN without waiting for an indication to proceed by waiting for an event from the group consisting of
receiving signaling in response to UE origination messaging for the PTT call,
receiving signaling in response to UE reverse short data burst signaling for the PTT call,
receiving channel assignment messaging for the PTT call, and
receiving signaling on a traffic channel assigned for the PTT call.

18. Fixed network equipment (FNE) for providing talk permit notification (TPN) for a push to talk (PTT) call, the FNE comprising:
a network interface; and
a processing unit, communicatively coupled to the network interface,
adapted to determine whether at least one condition is present for the PTT call that decreases the likelihood of successfully establishing the PTT call,
adapted to query, via the network interface, a communication system device for an indication to proceed with a TPN for the PTT call, before providing the TPN, if the at least one condition is present for the PTT call or a querying delay is expected to be less than an acceptable delay amount, and
adapted to provide the TPN without waiting for an indication to proceed with the TPN from the second communication system device if the at least one condition is not present for the PTT call.

19. The FNE of claim 18, wherein the at least one condition for the PTT call that decreases the likelihood of successfully establishing the PTT call is at least one condition from the group consisting of
a condition where the PTT call is a private call,
a condition where the PTT call is a group call for which all the group members must be available to establish the call,
a condition where a PTT target of the PTT call recently dropped due to RF loss,
a condition where an RF environment of a PTT target of the PTT call has recently been poor,
a condition where a serving cell of a PTT target of the PTT call effectively has no resources,
a condition where no signaling has recently occurred with a PTT target of the PTT call,
a condition where a PTT target of the PTT call has unchecked voice mail,
a condition where a PTT target of the PTT call has unchecked e-mail,
a condition where a PTT target of the PTT call has not responded to a recent short message service message,
a condition where a PTT target of the PTT call has not responded to a recent PTT talk burst, and
a condition where a PTT target of the PTT call has a low battery.

20. The FNE of claim 18, wherein the FNE comprises a PTT server, wherein the second communication system device comprises a device from the group consisting of a PTT target and a radio access network (RAN) serving the PTT target, and wherein the processing unit is further adapted to provide the TPN by indicating to user equipment (UE) to provide the TPN.
